(19) United States
(12) Patent Application Publication
(10) Pub. No.: US 2018/0225025 A1
(43) Pub. Date: Aug. 9, 2018

(54) TECHNOLOGIES FOR PROVIDING USER CENTRIC INTERFACES

(71) Applicant: Flybits Inc., Toronto, Ontario (CA)

(72) Inventors: Hossein Rahnama, Toronto (CA); Jordanne Pavao, Toronto (CA); Johnathon Callaghan, Toronto (CA)

(21) Appl. No.: 15/748,171

(22) PCT Filed: Jan. 8, 2016
(86) PCT No.: PCT/CA2016/050020

§ 371 Date: Jan. 26, 2018

(51) Int. Cl. G06F 3/0481; G06F 9/445; G06F 3/0484; H04M 1/725; G06F 3/0488; G06F 3/0485

(52) U.S. Cl. CPC G06F 3/04817; G06F 9/44526; G06F 3/0485; H04M 1/72569; G06F 3/0488; G06F 3/04842

(57) ABSTRACT

According to embodiments described in the specification, a server receives a request for content based on a user profile associated with a first user-controlled electronic device, a set of context plugins, and one or more contextual data parameters, generates a first stream and a second stream of icons associated with content types corresponding to a first dimension and a second dimension, determines a relevancy score for the content types, orders the content types in the first stream and in the second stream according to the relevancy score, populates the first stream at a first location on a display of the first user-controlled electronic device and the second stream at a second location on the display, provides a notification of the populating steps, and enables an electronic device to access the first stream and the second stream.

### FIELD OF TECHNOLOGY

The present disclosure relates to electronic devices, touch-sensitive displays, and interactive user interfaces. Certain embodiments disclose technologies for providing user centric interfaces.

### BACKGROUND

A typical electronic device includes a touch-sensitive display that provides navigable menus on the home screen, in an app, or elsewhere, permitting access to media and content such as apps, websites, social media posts, emails, messages, photos, contacts, calendar items, device settings, and so on.

It is a challenging problem to expose content, information, and tools relevant to users of electronic devices in a timely and convenient fashion. This problem is exacerbated at a time when electronic devices possess a great number of apps, services, content, notifications, messages, etc. that create a signal to noise problem in terms of locating relevant content. Navigating content and managing notification settings manually may lead to missing relevant content (e.g., when settings are muted) or digital distraction when all content is presented.

The operating system or an app or service loaded on a portable electronic device may assist a user's workflow when consuming or sharing content through graphical user interface (“GUI”) features such as a newsfeed, home screen, app launcher, share sheet, and the like. With the proliferation of apps and content among disparate sources, users face the burden of navigating and/or accessing multiple menus, screens and options to retrieve information, to carry out workflows such as sharing content among other apps and users. This problem is heightened on electronic devices such as smart phones, smart watches, smart bands, wearables, as well as Internet of Things devices, and other devices that provide reduced user interfaces, given their small size and physical limitations. Furthermore, according to past approaches, a different interface may need to be developed, tested and deployed for each specific device format.

Past techniques that attempt to expose content of interest to users include recommendation engines. These are software programs that seek to predict a rating or preference that a user would give to an item of content and typically rely on techniques such as machine learning, content-based or collaborative filtering. Such programs may not organize and present content using dimensional and contextual factors, among other limitations.

Some past solutions referred to generically as intelligent personal assistants and knowledge navigators are marketed under the brand names Siri, Cortana, and Google Now/Google Voice Search. Such voice-based solutions may provide recommendations but are limited in several aspects, including that they require voice based input, and respond to specific queries rather than exposing content passively. As well, such approaches do not typically present content based on dimensional and contextual factors.

Notwithstanding these past approaches, barriers to engagement with content loaded on electronic devices remain. A need exists for improved user interfaces on electronic devices.

Improvements in electronic devices with touch-sensitive displays are desirable.

The foregoing examples of the related art and limitations related thereto are intended to be illustrative and not exclusive. Other limitations of the related art will become apparent to those of skill in the art upon a reading of the specification and a review of the drawings.

### BRIEF DESCRIPTION OF THE DRAWINGS

Examples are illustrated with reference to the attached drawings. It is intended that the examples and figures disclosed herein be considered illustrative rather than restrictive.

FIG. 1 is a block diagram of a platform for providing user centric interfaces in accordance with an example;

FIG. 2 is a block diagram of an electronic device in accordance with an example;

FIG. 3 is a flowchart illustrating an example of a method of populating a user-centric interface on a display of the electronic device of FIG. 2; and

FIG. 4 to FIG. 7 are views illustrating example screenshots of a user centric interface for use in accordance with the method of FIG. 3.

### DETAILED DESCRIPTION

The following describes a platform including a plurality of user-controlled electronic devices, a server communicatively coupled to the plurality of user-controlled electronic devices and operable to execute the steps of: maintaining a plurality of user profiles, a plurality of content types, and a plurality of context plugins, receiving, from a first user-controlled electronic device, a request for content based on a first user profile, a first set of context plugins selected from the plurality of context plugins associated with the first user-controlled electronic device, and one or more contextual data parameters of the first user-controlled electronic device, generating a first stream corresponding to a first dimension, the first stream comprising one or more first icons associated with one or more first content types responsive to the request for content, generating a second stream corresponding to a second dimension, the second stream comprising one or more second icons associated with one or more second content types responsive to the request for content, wherein the first dimension and the second dimension are different, determining a relevancy score for the one or more first content types and the one or more second content types, ordering the first icons and the second icons according to the relevancy score, populating the first stream at a first location on a display of the first user-controlled electronic device, populating the second stream at a second location on the display, providing a notification of the populating, and enabling the first user-controlled electronic device to access the first stream and the second stream.

Throughout the following description, specific details are set forth in order to provide a more thorough understanding to persons skilled in the art. Well-known elements may not be shown or described in detail to avoid unnecessarily obscuring of the disclosure. Accordingly, the description and drawings are to be regarded in an illustrative, rather than a restrictive, sense.

This disclosure relates generally to electronic devices and displays, interactive user interfaces, and particularly to technologies for providing user centric interfaces.

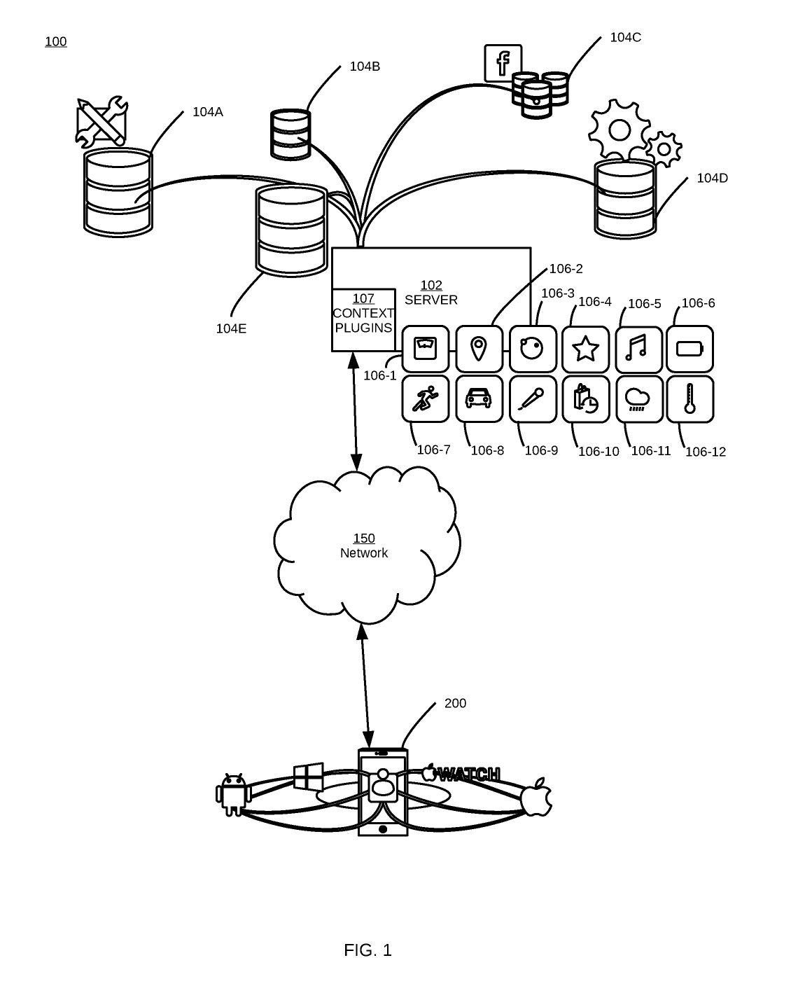

FIG. 1 illustrates a platform 100 for use with one or more electronic devices 200 according to a first example. According to this example, the platform 100 includes one or more electronic devices 200 (generically referred to herein as “electronic device 200” and collectively as “electronic devices 200”), all of which are connected to a server 102 via a network 150 such as the Internet.

Typically, the electronic devices 200 are associated with users who provide input for response from the server 102.

Generally speaking, the server 102 may be any entity that aggregates content and context from a number of data sources 104. The server 102 may host a website or application that allows a user, such as a user at the electronic device 200, to retrieve a content type 106 or to retrieve context plugins 107. Use of the term content item or content type 106 in the present specification refers to an identifier for file formats and format contents transmitted over a network such as the Internet. One such example is MIME. Use of the term content type 106 may also extend to the underlying data object identified by the identifier of the content type 106. Use of the term context plugin 107 in the present specification refers to a collection of data fields or services representing context elements associated with an electronic device (defined below) such as the status of a battery, a calendar event, a fitness metric, a location, a network condition, a weather parameter, and the like.

Generally speaking, a content type 106 includes an identifier for media objects such as a social media post, a status update, an email, a photograph, a video, a link, a shared content type, a gaming application achievement, a check-in event at a local business, a brand page, a contact, a calendar event, a health metric or other sensed parameter, a location, a favourite item, a song, a battery level, an activity, a task, a turn-by-turn direction, a sound, a reminder, a weather parameter, or any other type of content. In one example, objects in a content store, as maintained by a data source 104, represent single pieces of content types. Non-limiting examples of content types 106 are shown in FIG. 1, by way of illustration, including a health metric 106-1, a location 106-2, an application 106-3, a favourite content item 106-4, a song 106-5, a battery level 106-6, a workout 106-7, a turn-by-turn direction 106-8, a sound 106-9, a reminder 106-10, a weather condition 106-11, and a temperature 106-12. In one example, content types 106 may be maintained in volatile memory or persistent memory of the server 102, as discussed in further detail below.

In one example, a context plugin 107 may be defined or customized by a user or application developer using context rules. For example, a “Freezing” rule consisting of weather parameter<0 degrees Celsius defines a weather context plugin 107a.

The server 102 is typically a server or mainframe within a housing containing an arrangement of one or more processors, volatile memory (i.e., random access memory or RAM), persistent memory (e.g., hard disk or solid state devices) (not shown), and a network interface device (to allow the server 102 to communicate over the network 150) (not shown) interconnected by a bus (not shown). Many computing environments implementing the server 102 or components thereof are within the scope of the present specification. The server 102 may include a pair (or more) of servers for redundancy or load-balancing purposes, connected via the network 150 (e.g., an intranet or across the Internet) (not shown). The server 102 may be connected to other computing infrastructure including displays, printers, data warehouse or file servers, and the like. The server 102 may include a keyboard, mouse, touch-sensitive display (or other input devices), a monitor (or display, such as a touch-sensitive display, or other output devices) (not shown in FIG. 1).

The server 102 may include a network interface device interconnected with the processor that allows the server 102 to communicate with other computing devices such as the electronic devices 200 via a link with the network 150. The network 150 may include any suitable combination of wired and/or wireless networks, including but not limited to a Wide Area Network (WAN) such as the Internet, a Local Area Network (LAN), HSPA/EVDO/LTE cell phone networks, WiFi networks, and the like. The network interface device is selected for compatibility with the network 150. In one example, the link between the network interface device and the network is a wired link, such as an Ethernet link. The network interface device thus includes the necessary hardware for communicating over such a link. In other examples, the link between the server 102 and the network 150 may be wireless, and the network interface device may include (in addition to, or instead of, any wired-link hardware) one or more transmitter/receiver assemblies, or radios, and associated circuitry.

Still with reference to FIG. 1, one or more data sources 104 may store the content types 106, that is, store identifiers and/or objects representing various types of content. For example, a data source 104 may store a data structure including data having information fields describing characteristics of the objects. Different data structures may be stored for different types of objects. For example, for event type objects, the data source 104 includes data structures specifying the time and location for an event. Non-limiting examples of data sources 104 are shown in FIG. 1, by way of illustration, including office documents 104A, articles 104B, social media content 104C, settings 104D, and other content 104E. Typically, the server 102 may be coupled to the data source 104 over a bus or a network (such as network 150) and the server 102 may access or cache the content types 106 from the data source 104 at run-time or at pre-determined times using an API (application program interface).

In one example, the server 102 may be integral with the electronic device 200. According to this example, at least some of the content types 106 may be maintained directly on the electronic device 200, permitting user interfaces according to examples disclosed herein to be displayed and used in an “offline” mode.

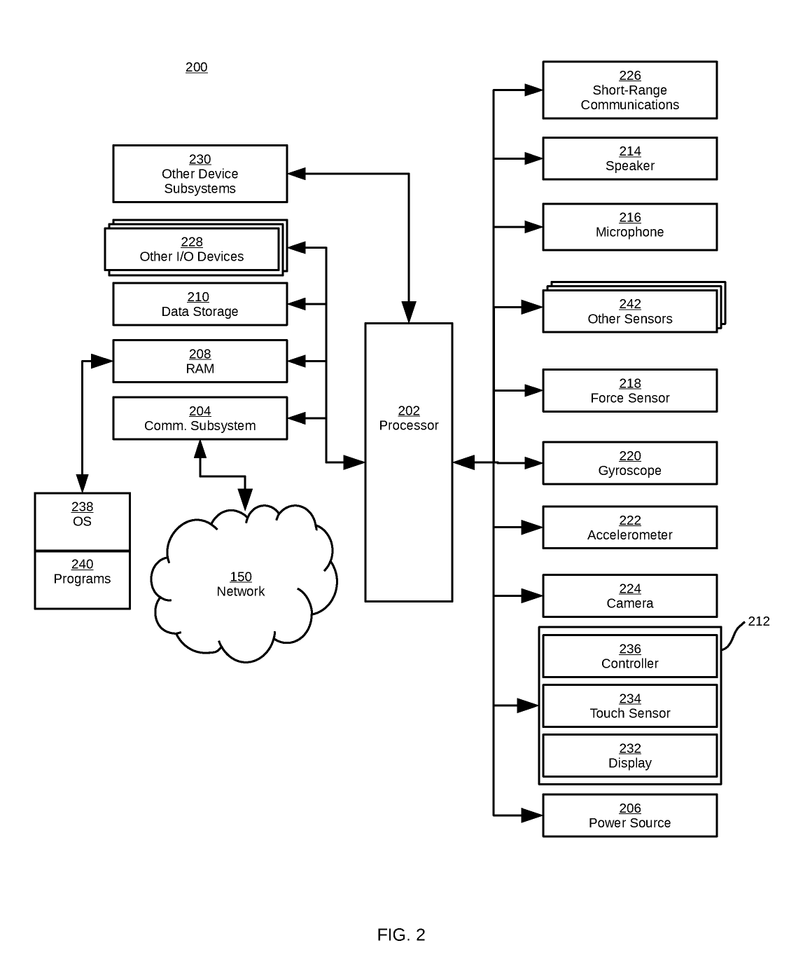

Turning now to FIG. 2, a block diagram of an example of an electronic device 200, also referred to as a mobile device or a device, is shown in FIG. 2. The electronic device 200 may be any of a desktop computer, smart phone, laptop computer, tablet computer, smart watch or other wearable device, Internet of Things appliance or device, and the like. According to one example, the electronic device 200 includes multiple components, such as a processor 202 that controls the overall operation of the electronic device 200. Communication functions, including data and voice communications, are performed through a communication subsystem 204. The communication subsystem 204 receives messages from and sends messages to a network 250. The network 250 may be any type of wired or wireless network, including, but not limited to, data wireless networks, voice wireless networks, and networks that support both voice and data communications. A power source 206, such as one or more rechargeable batteries or a port to an external power supply, powers the electronic device 200.

The processor 202 interacts with other components, such as a Random Access Memory (RAM) 208, data storage 210 (which may be cloud storage), a touch-sensitive display 212, a speaker 214, a microphone 216, one or more force sensors 218, one or more gyroscopes 220, one or more accelerometers 222, one or more cameras 224 (such as front facing camera 224a and back facing camera 224b), short-range communications subsystem 226, other I/O devices 228 and other subsystems 230. The touch-sensitive display 212 includes a display 232 and touch sensors 234 that are coupled to at least one controller 236 utilized to interact with the processor 202. Input via a graphical user interface is provided via the touch-sensitive display 212. Information, such as text, characters, symbols, images, icons, and other items that may be displayed or rendered on a mobile device, is displayed on the touch-sensitive display 212 via the processor 202. The electronic device 200 may include one or more sensors 242, such as micro-sensors using MEMS technology.

The touch-sensitive display 212 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth. As mentioned above, the capacitive touch-sensitive display includes one or more capacitive touch sensors 234. The capacitive touch sensors may comprise any suitable material, such as indium tin oxide (ITO).

One or more touches, also known as touch contacts or touch events, may be detected by the touch-sensitive display 212. The processor 202 may determine attributes of the touch, including a location of the touch. Touch location data may include data for an area of contact or data for a single point of contact, such as a point at or near a center of the area of contact. The location of a detected touch may include x and y components, e.g., horizontal and vertical components, respectively, with respect to one's view of the touch-sensitive display 212. A touch may be detected from any suitable input member, such as a finger, thumb, appendage, or other objects, for example, a stylus, pen, or other pointer, depending on the nature of the touch-sensitive display 212. Multiple simultaneous touches may be detected.

One or more gestures may also be detected by the touch-sensitive display 212. A gesture, such as a swipe, also known as a flick, is a particular type of touch on a touch-sensitive display 212 and may begin at an origin point and continue to an end point, for example, a concluding end of the gesture. A gesture may be identified by attributes of the gesture, including the origin point, the end point, the distance travelled, the duration, the velocity, and the direction, for example. A gesture may be long or short in distance and/or duration. Two points of the gesture may be utilized to determine a direction of the gesture. A gesture may also include a hover. A hover may be a touch at generally unchanged location over a period of time or a touch associated with the same selection item for a period of time.

Optional force sensors 218 may be disposed in conjunction with the touch-sensitive display 212 to determine or react to forces applied to the touch-sensitive display 212. The force sensors 218 may be force-sensitive resistors, strain gauges, piezoelectric or piezoresistive devices, pressure sensors, quantum tunneling composites, force-sensitive switches, or other suitable devices. Force as utilized throughout the specification, including the claims, refers to force measurements, estimates, and/or calculations, such as pressure, deformation, stress, strain, force density, force-area relationships, thrust, torque, and other effects that include force or related quantities. Optionally, force information associated with a detected touch may be utilized to select information, such as information associated with a location of a touch. For example, a touch that does not meet a force threshold may highlight a selection option, whereas a touch that meets a force threshold may select or input that selection option (e.g. force touch or 3D touch). Selection options include, for example, preview window, selection boxes or windows, function buttons, such as peek or pop on a piece of content; and so forth. Different magnitudes of force may be associated with different functions or input. As described below, a selection option may add or remove one or more content types or streams from the touch-sensitive display 212.

The electronic device 200 includes an operating system 238 and software programs, applications, or components 240 that are executed by the processor 202 and are typically stored in a persistent, updatable store such as the data storage 210. Additional applications or programs may be loaded onto the electronic device 200 through the wireless network 250, the short-range communications subsystem 226, or any other I/O devices 228 or subsystem 230.

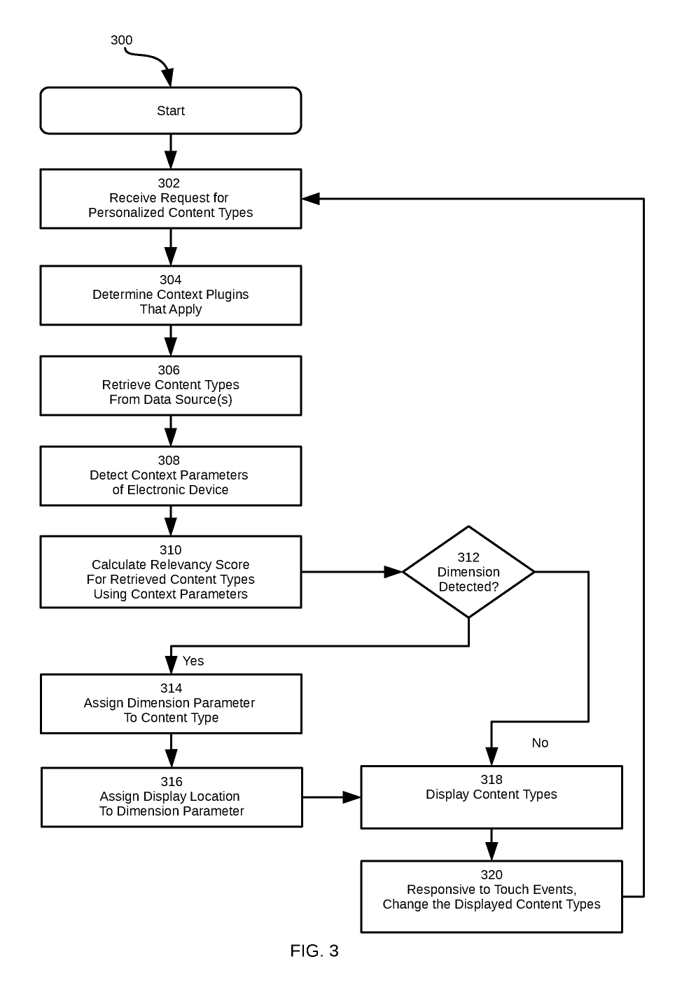

A flowchart illustrating an example of a method of populating a user centric interface on a touch-sensitive display 212 of electronic device 200 is shown in FIG. 3. The method may be carried out by software executed by, for example, processor 202. Coding of software for carrying out such a method is within the scope of a person of ordinary skill in the art given the present description. The method may contain additional or fewer processes than shown and/or described, and may be performed in a different order. Computer-readable code executable by at least one processor of the electronic device 200 to perform the method may be stored in a computer-readable storage medium, such as a non-transitory computer-readable medium.

When a request for personalized content types is detected on the electronic device 200 at 302, active context plugins 107 are determined at 304 and data fields representing content types 106 are retrieved from the data sources 104 for further evaluation at 306. Attributes of the electronic device 200 are determined by the server 102 at 308. Attributes include sensed data parameters from one or more sensors of the electronic device. Sensors can include location services, calendar services, weather services, health services, user activity services, and the like. With reference to 308, the attributes of the electronic device 200 may include one or more location parameters and one or more user parameters. Use of the term “location parameter” in the present specification may refer to any cellular, Wi-Fi, Global Positioning System (GPS), and/or Bluetooth data of the electronic device 200 that may be used to determine approximate location of the electronic device 200, while use of the term “user parameter” may refer to any non-location parameter of the electronic device 200 or a user thereof that may assist in determining a relevancy score. At 310, relevancy scores for a content type or content types is calculated. If a location parameter or a user parameter is not available, as when a new electronic device 200 has been activated, a default context parameter or template is used, and the method continues at 310. As mentioned above, the attributes of the electronic device may include one or more dimension parameters, detected at 312. Use of the term “dimension parameter” refers to a layer or category of content type, such as a semantic layer. Use of the term “relevancy score” refers to an integer or other numerical score used for ordering content types. Content types are categorized according to a dimension at 314, and assigned a display location at 316, and the resulting stream or streams of content types are populated on the touch-sensitive display 212 of the electronic device 200 at 318. The method senses touch-sensitive input to display different or additional content types at 320, and returns to step 302 upon receipt of a new request for content types, as by re-loading of the app, performing a gesture to refresh, after the passage of a pre-determined period of time, which may be adjustable by the user or the system, and the like.

Use of the technologies disclosed herein permits a user to be supported in decision-making through a spatial or conceptual distance model. According to one example, content that is most relevant to a user at a given point in time may be oriented at a central point of the interface.

Advantageously, the user does not have to search for information. Relevant information is presented to the user automatically providing a situational display, and potentially reducing the the number of apps that need to be consulted or installed on the electronic device 200.

Accordingly, some examples of the present specification may provide a distraction-free user interface that reduces or helps to mitigate app fatigue. The user interface is scalable, suitable for use in device formats of various sizes. According to some examples, the user interface may provide decision support by summarizing content types through an adjusting, browsable iconic display.

The term stream or layer in the present specification refers to a content or a type of a content type. In one example, a stream may be a content type, such as music. In another example, a stream may be a semantic descriptor, such as contacts or calendar events, a social media service, a location, an application.

The interfaces disclosed herein may scale to fit various screen-based displays extending to mobile devices such as smart phones and tablets, as well as wearables.

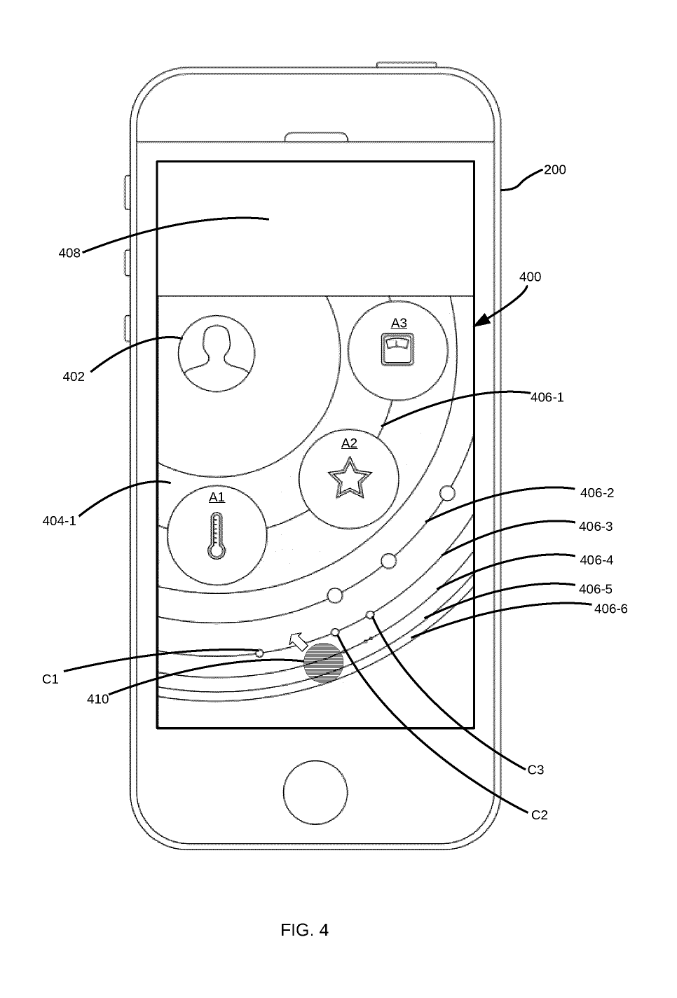

Examples of screenshots on the display of the electronic device 200 when loaded with an application to operate in accordance with the present disclosure are depicted in FIG. 4 through FIG. 7 and described with continued reference to FIG. 3.

With reference to FIG. 4, screenshot 400 may be launched by opening a client application on the electronic device 200. In this example, a first stream of icons A1, A2, A3 is associated with content types 106 is shown on the display at location 404-1 along a line of axis 406-1 at step 314. Additional streams of icons are shown along lines 406-2, 406-3, 406-4, 406-5, and 406-6. More or fewer streams may be shown according to different examples. An avatar 402 provides information about the active user, which may be an image. In one example, the first stream of icons along location 404-1 represents the content types 106 having the highest relevancy score, organized according to one or more dimensional parameters. Region 408 may be operable to display title graphics, default buttons, filter tools, or other user-interface elements. The term icon refers to a pictogram displayed on the display to help the user navigate a computer system or mobile device. The shape, color, size, animation, location, localization, etc. of an icon or icons may be changed without departing from the scope of the present specification.

In one example, default or a priori icons associated with content types 106 may be displayed in a single stream. The electronic device 200 may be operable to add more streams, based on user preferences or system generated recommendations using heuristics such as a collaborative filtering heuristic, a machine learning heuristic or another heuristic. User interaction history may be captured in the user profile described above.

In one example, a notification can be provided when a new content type has been detected. This notification can take many forms, including an animation, a visualization such as a blue dot or a red dot beside the icon associated with the new content type. The icon associated with the new content type may be populated in a prominent location in the stream, at the top, bottom, or otherwise. According to one example, icons representing content types can be manually adjusted by changing location (a tap and hold gesture, followed by a tap on a “X” visualization). In one example, the size of icons may be adjusted manually or algorithmically; content types with a high relevancy score (or chronologically newer in some cases) can be associated with icons that are larger, or smaller, in size relative to other icons. According to other examples, icons or streams can be adjusted in size, shape, colour, etc. based on the dimensional parameter. For example, a stream associated with social media services may have a different shading compared to a stream associated with calendar events.

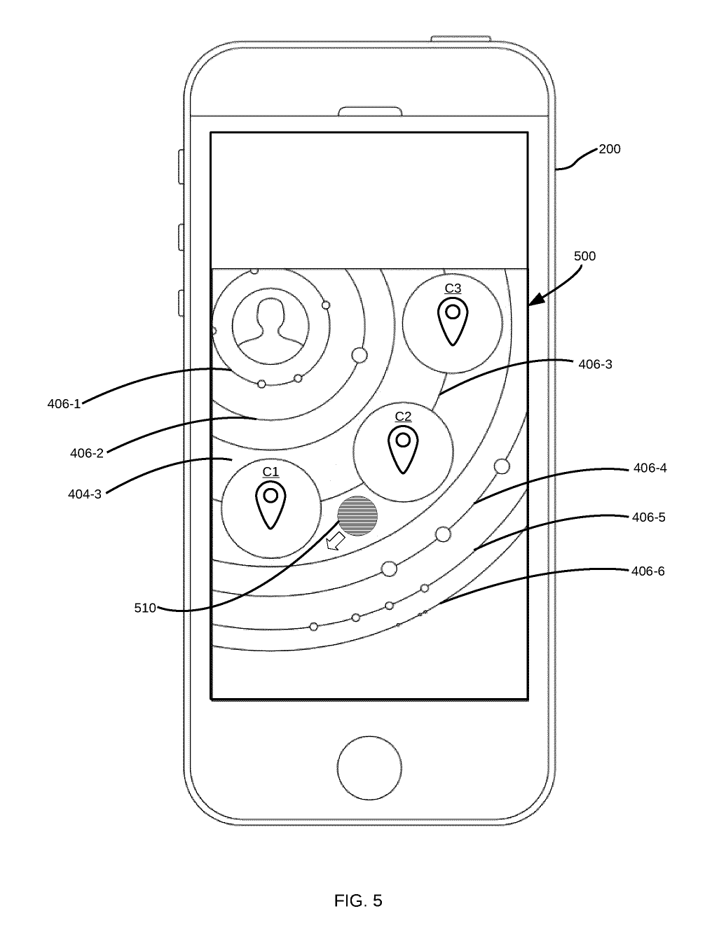

Turning to FIG. 5, screenshot 500 may be launched by changing screenshot 400, responsive to a touch event. Detecting a gesture at location 410 of FIG. 4 (in a direction shown by the arrow) causes the first stream of icons at location 404-1 to be minimized, and the third stream of icons C1, C2, C3 shown at location 404-3 to be populated on the display.

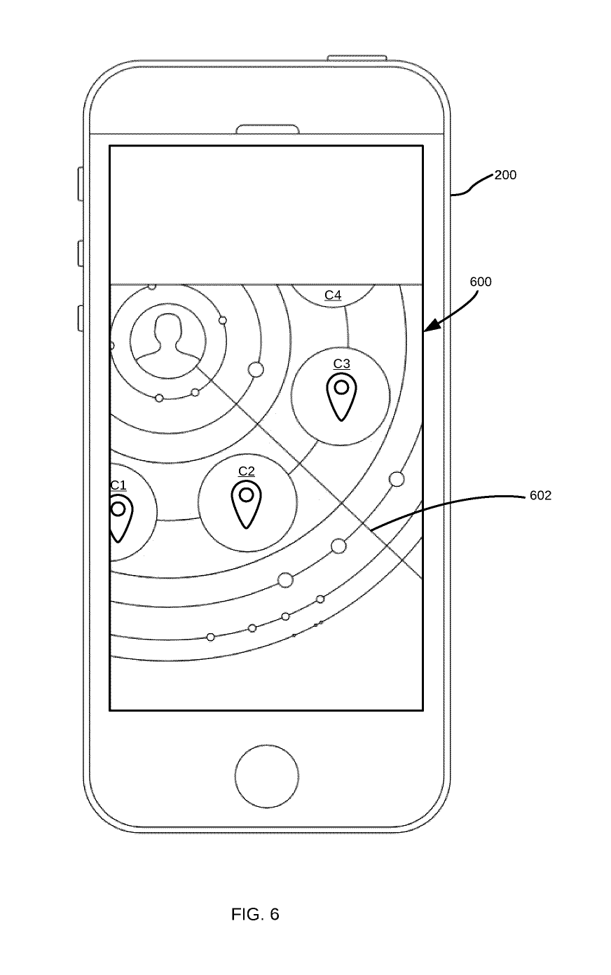

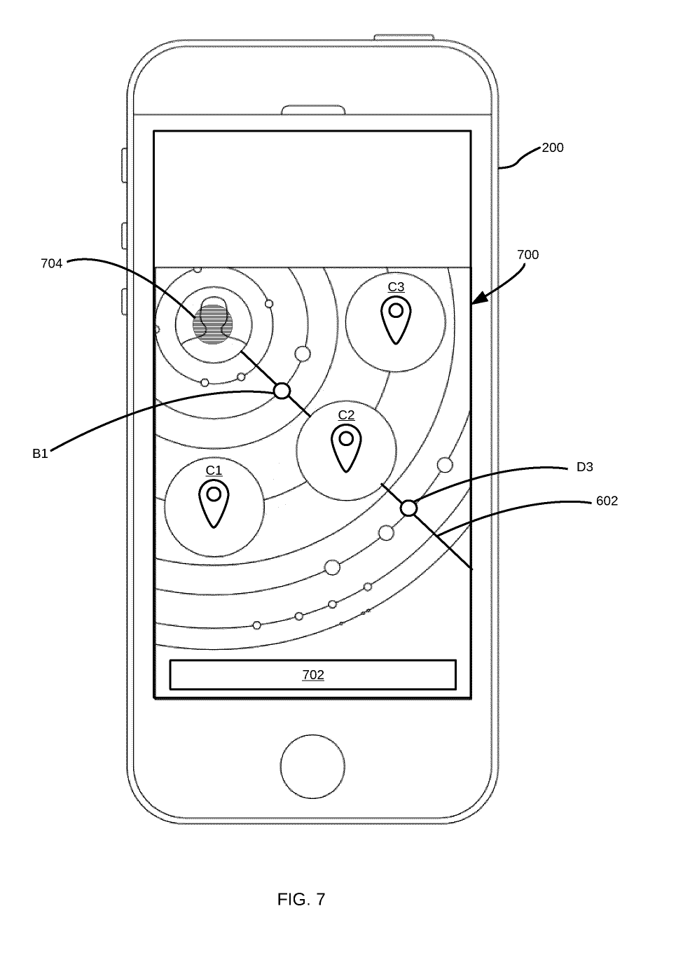

Now with reference to FIG. 6, screenshot 600 may be launched by changing screenshot 500, responsive to a gesture event. Detecting a gesture at location 510 (in a direction shown by the arrow) causes the icons representing the third stream of content types to be rotated, revealing a new icon C4 associated with a new content type, providing a scrolling effect. FIG. 6 illustrates an optional line 602 that may be displayed, in one example. Icons that are rotated to be close to line 602 may facilitate a zoom action, a group selection, or may set up a workflow in respect of associated content types from different streams 406, such as sharing, or opening a content type from a first stream in an app denoted by a second stream. Alternatively, an icon in the path of line 602 may act like a selection or zoom and trigger additional information to be displayed about the selection, such as a preview, or detail view, or the like (shown in area 702 in FIG. 7). The line 602 may extend to the edge of the screen. In one example, the line 602 may be of shorter or longer length, or may be a different shape. In one example, icons associated with content types that are aligned with line 602 may represent most relevant content within a stream 406, permitting convenient navigation of content across multiple semantic layers or dimensions of information.

Turning to FIG. 7, screenshot 700 may be launched by changing screenshot 600, responsive to a gesture event. Detecting a touch at 704 triggers area 702 to be displayed, providing more information about content types represented by icons B1, C2 and D3, which are aligned with line 602.

One scenario of use will now be described. A user device loaded with a calendar application may detect an upcoming calendar event and populate a number of streams with content types. The content types populated on the display may include the calendar event itself, the LinkedIn or other social media profile of one or more attendees, a Foursquare or location profile of the meeting place defined by the calendar event, and a map location or ETA of one or more attendees. It will be appreciated that, according to this scenario, the user interface techniques disclosed herein provide a convenient, summarized display of contextual and relevant content types.

In one example, the user interface may be arranged in a radial interface, as shown in FIG. 4 to FIG. 7. Other configurations are possible without departing from the scope of the present specification. The radial interface may be displayed so that the avatar 402 is in the middle or off-set as shown in FIG. 4 to FIG. 7. It has been discovered that off-setting the avatar 402 permits additional content to be located in a radial, or ring-like, structure. Interaction may be streamlined because arranging the content about a radial interface permits convenient interaction; the user does not have to do anything more than shift his or her thumb. Moreover, locating the streams 406 about a centrally located avatar 402 permits less screen real estate to be used on touch-sensitive displays 212 that are rectangular.

It will be appreciated that resizing or movement of the icons representing content types may be animated at a rate or speed dependent on the touch events or gesture events. Thus, a slow gesture may be used to resize and move the icons slowly to new locations. A faster gesture may be used to resize and move the icons more quickly.

The resizing of the icons may be gradual, such that the icon sizes gradually decrease in size from a first stream, to a second stream, and so on. Alternatively, the icons may be grouped and the resizing of the icons may be uniform within a group, such that all streams other than the active stream, for example, are sized uniformly or by one factor (e.g. in the same proportion).

Resizing icons by gesture or touch events, may be carried out without switching or interrupting tasks. Moreover, the change and movement of the icons along their respective paths may be displayed on the touch-sensitive display 212. Ready identification of the new locations of icons may be facilitated by graphically animating the resizing or movement of the icons.

Advantageously, use of the user centric interface according to disclosed examples permits navigation of streams of clustered information. As well, content types from disparate sources may be consumed and shared in a non-linear graphical user interface. Multiple actions may be combined in a single interface to facilitate sharing, commenting, tagging, and the like.

According to disclosed examples, sharing content types may be facilitated by the user interfaces disclosed herein. For example, data representing content C2 shown in FIG. 5 may be shared with a different electronic device 200. According to this example, one of the displayed streams may include icons representing sharing tools, and a second of the displayed streams may represent a contact stored in the electronic device 200. Content type C2 is positioned in the same axis (e.g. as by line 602 in FIG. 6) as contact D3 and tool E1 (e.g. a messenger program) may be shared. Alternatively, a constellation of content types may be shared, enabling a rich sharing of moments or stories, i.e., multiple content types.

According to some examples, streams may be related to other streams and organized in a hierarchy or other taxonomy, permitting a browsable semantic interface. The organization of the streams may be adjusted using an authoring component of server 102, according to one example. According to this example, the authoring component may provide a user interface to manage or adjust relevancy score calculation, dimensions of content types, or add/remove content types. This can be seen as an alternative to a user or brand managing a web page or social media newsfeed.

In one example, the server 102 includes an analytics component. The analytics component captures patterns of interaction by the electronic devices 200. For example, the analytics component can count the impressions of a given icon associated with a content type. An impression may be a viewing event, a gesture event, or a break in a gesture event. The analytics component can adjust the presentation of one or more streams, responsive to the tracked interactions. For example, the order or the size or the dimension of icons and associated content types may change based on the tracked interactions, either for a given electronic device, a group or in aggregate.

Furthermore, in one example, the server 102 includes a permission management component that adjusts the relevancy score (e.g., using a visibility parameter) when the given user-controlled electronic device or associated user profile does not have appropriate privacy permissions to view, edit, or interact with a content type. The permission management component may be operable to adjust the relevancy score if the content type owner represented by data source 104 is the same as the electronic device user, if the content type is public, and so on.

The present specification provides a platform including a plurality of user-controlled electronic devices, a server communicatively coupled to the plurality of user-controlled electronic devices and operable to execute the steps of: maintaining a plurality of user profiles, a plurality of content types, and a plurality of context plugins, receiving, from a first user-controlled electronic device, a request for content based on a first user profile, a first set of context plugins selected from the plurality of context plugins associated with the first user-controlled electronic device, and one or more contextual data parameters of the first user-controlled electronic device, generating a first stream corresponding to a first dimension, the first stream comprising one or more first icons associated with one or more first content types responsive to the request for content, generating a second stream corresponding to a second dimension, the second stream comprising one or more second icons associated with one or more second content types responsive to the request for content, wherein the first dimension and the second dimension are different, determining a relevancy score for the one or more first content types and the one or more second content types, ordering the first icons and the second icons according to the relevancy score, populating the first stream at a first location on a display of the first user-controlled electronic device, populating the second stream at a second location on the display, providing a notification of the populating, and enabling the first user-controlled electronic device to access the first stream and the second stream.

Instructions described herein can be stored on a non-transitory computer-readable storage medium.

The first dimension can include one or more of: applications, social media services, calendar items, and contacts.

The first stream can be populated at the first location including a first area of the display and the second stream can be populated at the second location including a second area of the display, wherein the first area is different than the second area.

Responsive to a first touch event including a first gesture in a first direction, an aspect of the first area can be changed relative to the second area, in proportion to one or more parameters of the first touch event.

Responsive to a second touch event including a second gesture in a second direction, one of the first stream and the second stream can be adjusted to provide a scrolling effect.

The contextual data parameters can include sensed data parameters from one or more sensors of the first user-controlled electronic device.

The sensors can include location services, calendar services, audio services, video services, weather services, health services, and user activity services.

The server can be further operable to execute the steps of: accepting input including an identification of a first selected icon from the first stream and a second selected icon from the second stream, recognizing a workflow defined by an association between the first selected icon and the second selected icon, carrying out the workflow, and displaying a product of the workflow on the display. The generating can include adjusting one of the first stream and the second stream with icons associated with content types including targeted advertising messages.

The relevancy score can include an integer that is based on a heuristic selected from one of: a collaborative filtering heuristic and a machine learning heuristic.

The relevancy score can include a visibility parameter including a data field describing when the first user-controlled electronic device has privacy permission to interact with the one or more of the plurality of content types.

The plurality of context plugins can be selected from one or more of: location, health, preferential, interpreted context and synthesized and distributed context.

The first set of context plugins can be selected from one of: user defined plugins and administrator defined plugins.

While a number of exemplary aspects and examples have been discussed above, those of skill in the art will recognize certain modifications, permutations, additions and sub-combinations thereof.

1. A platform comprising:
a plurality of user-controlled electronic devices;
a server communicatively coupled to the plurality of user-controlled electronic devices and operable to execute the steps of:
maintaining a plurality of user profiles, a plurality of content types, and a plurality of context plugins;
receiving, from a first user-controlled electronic device, a request for content based on a first user profile, a first set of context plugins selected from the plurality of context plugins associated with the first user-controlled electronic device, and one or more contextual data parameters of the first user-controlled electronic device;
generating a first stream corresponding to a first dimension, the first stream comprising one or more first icons associated with one or more first content types responsive to the request for content;
generating a second stream corresponding to a second dimension, the second stream comprising one or more second icons associated with one or more second content types responsive to the request for content, wherein the first dimension and the second dimension are different;
determining a relevancy score for the one or more first content types and the one or more second content types;
ordering the first icons and the second icons according to the relevancy score;
populating the first stream at a first location on a display of the first user-controlled electronic device;
populating the second stream at a second location on the display;
providing a notification of the populating; and
enabling the first user-controlled electronic device to access the first stream and the second stream.

2. The platform of claim 1 wherein the first dimension comprises one or more of: applications, social media services, calendar items, and contacts.

3. The platform of claim 1 wherein the first stream is populated at the first location comprising a first area of the display and the second stream is populated at the second location comprising a second area of the display, wherein the first area is different than the second area.

4. The platform of claim 3, further comprising:
responsive to a first touch event comprising a first gesture in a first direction, changing an aspect of the first area relative to the second area, in proportion to one or more parameters of the first touch event; and
responsive to a second touch event comprising a second gesture in a second direction, adjusting one of the first stream and the second stream to provide a scrolling effect.

5. The platform of claim 1 wherein the contextual data parameters comprise sensed data parameters from one or more sensors of the first user-controlled electronic device.

6. The platform of claim 5 wherein the sensors comprise: location services, calendar services, audio services, video services, weather services, health services, and user activity services.

7. The platform of claim 1 wherein the server is further operable to execute the steps of:
accepting input comprising an identification of a first selected icon from the first stream and a second selected icon from the second stream;
recognizing a workflow defined by an association between the first selected icon and the second selected icon;
carrying out the workflow; and
displaying a product of the workflow on the display.

8. The platform of claim 7 wherein the generating comprises adjusting one of the first stream and the second stream with icons associated with content types comprising targeted advertising messages.

9. The platform of claim 1 wherein the relevancy score comprises an integer that is based on a heuristic selected from one of: a collaborative filtering heuristic and a machine learning heuristic.

10. The platform of claim 9 wherein the relevancy score comprises a visibility parameter comprising a data field describing when the first user-controlled electronic device has privacy permission to interact with the one or more of the plurality of content types.

11. The platform of claim 1 wherein the plurality of context plugins is selected from one or more of: location, health, preferential, interpreted context and synthesized and distributed context.

12. The platform of claim 11 wherein the first set of context plugins is selected from one of: user defined plugins, and administrator defined plugins.

13. At least one non-transitory computer-readable storage medium storing instructions that, when executed by at least one processor, cause the at least one processor to:
maintain a plurality of user profiles, a plurality of content types, and a plurality of context plugins;
receive, from a first user-controlled electronic device, a request for content based on a first user profile, a first set of context plugins selected from the plurality of context plugins associated with the first user-controlled electronic device, and one or more contextual data parameters of the first user-controlled electronic device;
generate a first stream corresponding to a first dimension, the first stream comprising one or more first icons associated with one or more first content types responsive to the request for content;
generate a second stream corresponding to a second dimension, the second stream comprising one or more second icons associated with one or more second content types responsive to the request for content, wherein the first dimension and the second dimension are different;
determine a relevancy score for the one or more first content types and the one or more second content types;
order the first icons and the second icons according to the relevancy score;
populate the first stream at a first location on a display of the first user-controlled electronic device;
populate the second stream at a second location on the display;
provide a notification of the populating; and
enable the first user-controlled electronic device to access the first stream and the second stream.
